(19) United States
(12) Patent Application Publication
(10) Pub. No.: US 2019/0079340 A1
(43) Pub. Date: Mar. 14, 2019

(54) REFLECTIVE LIQUID CRYSTAL DISPLAY

(71) Applicant: CHUNGHWA PICTURE TUBES, LTD., Taoyuan City (TW)

(72) Inventors: Shin-Yi CHENG, New Taipei City (TW); Chien-Hua CHEN, Hsinchu County (TW); Jan-Tian LIAN, Keelung City (TW)

(21) Appl. No.: 15/810,120

(22) Filed: Nov. 12, 2017

(30) Foreign Application Priority Data
Sep. 14, 2017 (CN) 201710827590.9

(51) Int. Cl. G02F 1/1335

(52) U.S. Cl. CPC G02F 1/133504; G02F 1/133553

(57) ABSTRACT

The present disclosure discloses a reflective liquid crystal display which includes a reflective layer, a light scattering adhesive layer, an array substrate, a color filter substrate, and a liquid crystal layer. The light scattering adhesive layer is positioned on the reflective layer and includes an adhesive layer and a plurality of light scattering particles dispersing in the adhesive layer. The array substrate is positioned on the light scattering adhesive layer. The color filter substrate is disposed opposite to and on the array substrate. The liquid crystal layer is disposed between the array substrate and the color filter substrate. By using the light scattering particles in the light scattering adhesive layer to scatter the light entering the light scattering adhesive layer, the reflective liquid crystal display can have higher ambient light utilization rate and provide a display screen with high contrast and high visibility.

### CROSS-REFERENCE TO RELATED APPLICATION

This application claims priority to China Application Serial Number 201710827590.9, filed Sep. 14, 2017, the disclosures of which are incorporated herein by reference in their entireties.

### BACKGROUND

### Field of Invention

The present invention relates to display technology. More particularly, the present invention relates to a reflective liquid crystal display (LCD).

### Description of Related Art

With vigorous development of mobile devices and wearable equipment, requirement for light, thin, and power-saving display increases. Although display properties of traditional liquid crystal displays and organic light-emitting diode (OLED) displays, such as color and resolution, can satisfy most requirement, when the displays are disposed in mobile devices and wearable equipment, higher power consumption of the displays may limit standby time or usage time of the devices and equipment.

Reflective liquid crystal displays do not require backlight and can use an ambient light as light source, thereby having power-saving property. Accordingly, the reflective liquid crystal displays are suitable for applying in mobile devices and wearable equipment.

In order to further improve various properties of the reflective liquid crystal displays, researchers in related fields exhaust the subject. More specifically, how to further promote the display quality of the reflective liquid crystal displays is the target pursued by the researchers in related fields.

### SUMMARY

In order to promote display quality of reflective liquid crystal displays, the target of the present disclosure is to provide a reflective liquid crystal display with high contrast and high reflectivity.

One embodiment of the present disclosure provides a reflective liquid crystal display which includes a reflective layer, a light scattering adhesive layer, an array substrate, a color filter substrate, and a liquid crystal layer. The light scattering adhesive layer is positioned on the reflective layer and includes an adhesive layer and a plurality of light scattering particles dispersing in the adhesive layer. The array substrate is positioned on the light scattering adhesive layer. The color filter substrate is disposed opposite to and on the array substrate. The liquid crystal layer is disposed between the array substrate and the color filter substrate.

In one or more embodiments of the present disclosure, the light scattering adhesive layer is in direct contact with the array substrate.

In one or more embodiments of the present disclosure, the light scattering adhesive layer is in direct contact with the reflective layer.

In one or more embodiments of the present disclosure, the plurality of light scattering particles include an inorganic particle, an organic particle, or a combination thereof.

In one or more embodiments of the present disclosure, a material of the inorganic particle includes silicon dioxide (SiO₂), titanium dioxide (TiO₂), aluminium oxide (Al₂O₃), indium oxide (In₂O₃), tin oxide (SnO₂), antimony trioxide (Sb₂O₃), zinc oxide (ZnO), zirconium dioxide (ZrO₂), indium tin oxide (ITO), glass, or a combination thereof.

In one or more embodiments of the present disclosure, a material of the organic particle includes polycarbonate (PC), polyurethane (PU), epoxy, acrylic resin, phenol formaldehyde resin (PF), or a combination thereof.

In one or more embodiments of the present disclosure, a particle size of each light scattering particle ranges between about 3 μm and about 50 μm.

In one or more embodiments of the present disclosure, an average particle size of the plurality of light scattering particles ranges between about 3 μm and about 50 μm.

In one or more embodiments of the present disclosure, a material of the adhesive layer includes an optical clear adhesive (OCA), an optical clear resin (OCR), or a combination thereof.

In one or more embodiments of the present disclosure, a thickness of the light scattering adhesive layer ranges between about 30 μm and about 100 μm.

The advantages of the present disclosure includes:

(1) In the reflective liquid crystal display of the present disclosure, the light scattering adhesive layer is disposed between the reflective layer and the array substrate. When light from an ambient light source enters the reflective liquid crystal display, the light scattering particles in the light scattering adhesive layer may scatter the light entering the light scattering adhesive layer, such as the light reflected by the reflective layer, thereby homogenizing the light entering the liquid crystal layer from the light scattering adhesive layer. Therefore, the reflective liquid crystal display of the present disclosure can have higher ambient light utilization rate and provide a display screen with high contrast and high visibility.
(2) In some embodiments of the present disclosure, it is unnecessary to dispose an alignment film or a polarizer within the reflective liquid crystal display, such that the reflective liquid crystal display is lighter and thinner.

### BRIEF DESCRIPTION OF THE DRAWINGS

FIG. 1 is a cross section view of a reflective liquid crystal display according to some embodiments of the present disclosure.

FIG. 2 is a display image of a reflective liquid crystal display according to some embodiments of the present disclosure.

FIG. 3 is a display image of a reflective liquid crystal display without a light scattering adhesive layer.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

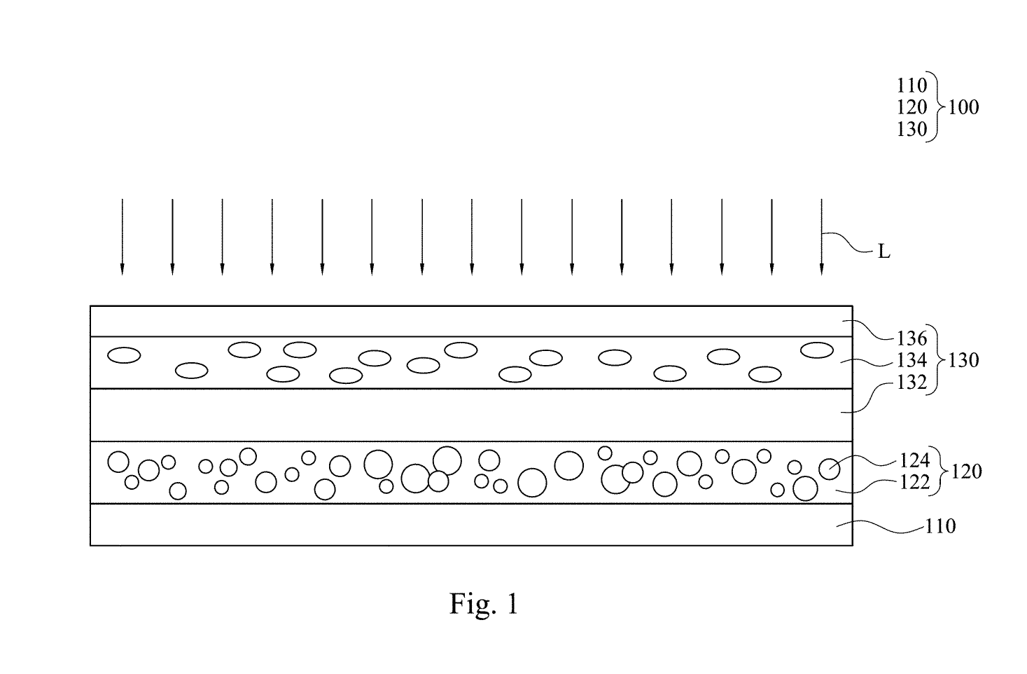

FIG. 1 is a cross section view of a reflective liquid crystal display 100 according to some embodiments of the present disclosure. The reflective liquid crystal display 100 includes a reflective layer 110, a light scattering adhesive layer 120, and a liquid crystal panel 130. The light scattering adhesive layer 120 is positioned on the reflective layer 110 and includes an adhesive layer 122 and a plurality of light scattering particles 124 dispersing in the adhesive layer 122. The liquid crystal panel 130 includes an array substrate 132, a liquid crystal layer 134, and a color filter substrate 136. The array substrate 132 is positioned on the light scattering adhesive layer 120. The color filter substrate 136 is disposed opposite to and on the array substrate 132. The liquid crystal layer 134 is disposed between the array substrate 132 and the color filter substrate 136.

In one or more embodiments of the present disclosure, a material of the reflective layer 110 includes a metal. Preferably, the material of the reflective layer 110 includes a metal having high reflectivity. For example, the material of the reflective layer 110 includes silver, aluminum, chromium, copper, titanium, gold, or a combination thereof.

When the light L from an ambient light source (e.g. sun or light bulb) enters the reflective liquid crystal display 100, the light scattering particles 124 in the light scattering adhesive layer 120 may scatter the light L entering the light scattering adhesive layer 120, such as the light L reflected by the reflective layer 110, thereby homogenizing the light L entering the liquid crystal layer 134 from the light scattering adhesive layer 120. Therefore, the reflective liquid crystal display 100 of the present disclosure can have higher ambient light utilization rate and provide a display screen with high contrast and high visibility. In one or more embodiments of the present disclosure, a thickness of the light scattering adhesive layer 120 ranges between about 30 μm and about 100 μm. However, according to design requirement, the thickness of the light scattering adhesive layer 120 can be adjusted.

In one or more embodiments of the present disclosure, the light scattering adhesive layer 120 is used for adhering the reflective layer 110 to the array substrate 132. The light scattering adhesive layer 120 is in direct contact with the array substrate 132 and also in direct contact with the reflective layer 110.

In one or more embodiments of the present disclosure, a material of the adhesive layer 122 in the light scattering adhesive layer 120 includes an optical clear adhesive (OCA), an optical clear resin (OCR), or a combination thereof. In one or more embodiments of the present disclosure, the material of the adhesive layer 122 includes colloidal resin. For example, the material of the adhesive layer 122 includes acrylic resin, epoxy resin, phenolic resin, urea-formaldehyde resin, unsaturated resin, polyurethane, polyimide, polyester resin, polyether resin, polyurethane resin, acrylic polymer or a combination thereof. In one or more embodiments of the present disclosure, a thickness of the adhesive layer 122 ranges between about 30 μm and about 100 μm. However, according to design requirement, the thickness of the adhesive layer 122 can be adjusted.

In one or more embodiments of the present disclosure, the light scattering particles 124 in the light scattering adhesive layer 120 include an inorganic particle, an organic particle, or a combination thereof. More specifically, the light scattering particles 124 may include at least one inorganic particle, at least one organic particle, or a mixture of at least one inorganic particle and at least one organic particle. In one or more embodiments of the present disclosure, the light scattering particles 124 are transparent particles.

For example, a material of the inorganic particle includes silicon dioxide (SiO₂), titanium dioxide (TiO₂), aluminium oxide (Al₂O₃), indium oxide (In₂O₃), tin oxide (SnO₂), antimony trioxide (Sb₂O₃), zinc oxide (ZnO), zirconium dioxide (ZrO₂), indium tin oxide (ITO), glass, or a combination thereof. A material of the organic particle is transparent resin. For example, the material of the organic particle includes polycarbonate (PC), polyurethane (PU), epoxy, acrylic resin, phenol formaldehyde resin (PF), or a combination thereof. In one or more embodiments of the present disclosure, the material of the light scattering particles 124 is different from the material of the adhesive layer 122.

In one or more embodiments of the present disclosure, a particle size of each light scattering particle 124 ranges between about 3 μm and about 50 μm. In one or more embodiments of the present disclosure, an average particle size of the light scattering particles ranges between about 3 μm and about 50 μm. In one or more embodiments of the present disclosure, the particle size of each light scattering particle 124 is same with or different from the particle size of another light scattering particle 124.

In one or more embodiments of the present disclosure, the liquid crystal panel 130 is a scattering type liquid crystal panel. The liquid crystal layer 134 includes scattering type liquid crystal material. Therefore, it is unnecessary to dispose an alignment film or a polarizer within the reflective liquid crystal display 100, such that the reflective liquid crystal display 100 is lighter and thinner.

In one or more embodiments of the present disclosure, the array substrate 132 of the liquid crystal panel 130 is an active array substrate. By using thin-film transistors (TFTs) in the active array substrate to control the direction of liquid crystal molecules in the liquid crystal layer 134, the liquid crystal layer 134 may allow light to pass through or block it.

In one or more embodiments of the present disclosure, the reflective liquid crystal display 100 further includes a polarizer (not shown) on the liquid crystal panel 130. More specifically, the polarizer is on the color filter substrate 136.

In one or more embodiments of the present disclosure, the reflective liquid crystal display 100 further includes an alignment film (not shown) between the array substrate 132 and the liquid crystal layer 134 and another alignment film (not shown) between the liquid crystal layer 134 and the color filter substrate 136.

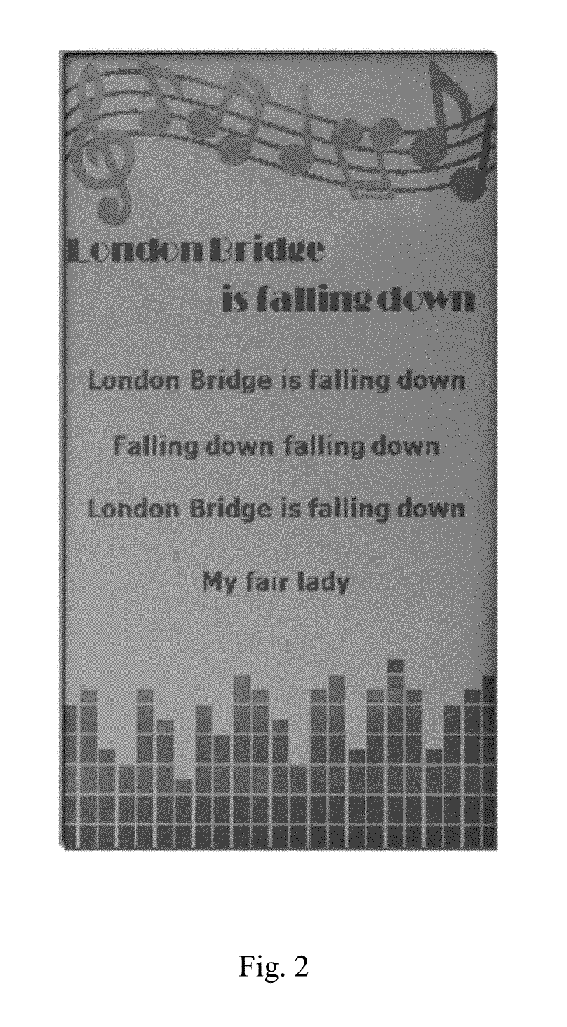

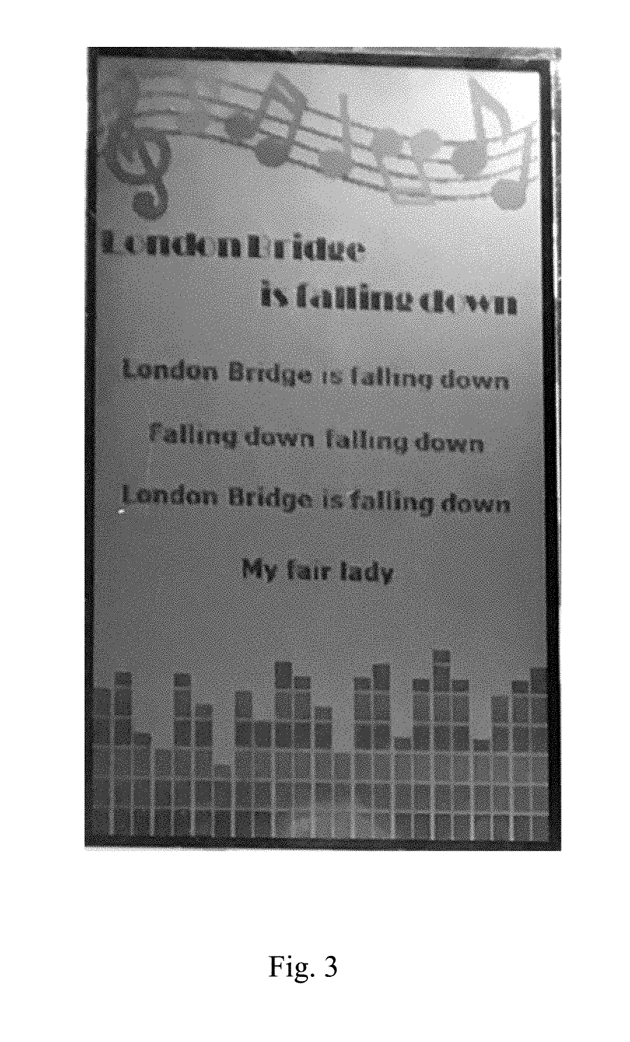

FIG. 2 is a display image of the reflective liquid crystal display 100 according to some embodiments of the present disclosure. In the reflective liquid crystal display 100, the material of the adhesive layer 122 is acrylic resin, and the light scattering particles 124 are a mixture of silicon dioxide particles, aluminium oxide particles, titanium dioxide particles, glass powder, and polycarbonate particles. A particle size of each particle ranges between about 3 μm and about 50 μm. The liquid crystal panel 130 is a scattering type liquid crystal panel. Further, FIG. 3 is a display image of another reflective liquid crystal display. The difference between the reflective liquid crystal display and the reflective liquid crystal display 100 is that the reflective liquid crystal display does not include the light scattering adhesive layer 120. In other words, FIG. 3 is a display image of a reflective liquid crystal display without the light scattering adhesive layer 120.

Next, FIG. 2 is compared with FIG. 3. As shown in FIG. 2, the pattern and text are clear and distinguishable, and the display image has uniform brightness and high contrast. By contrast, the pattern and text of FIG. 3 are blurry, and the upper right corner region is brighter than other region. The display image of FIG. 3 has uneven brightness and low contrast. It proves that disposing the light scattering adhesive layer 120 between the liquid crystal panel 130 and the reflective layer 110 can make the reflective liquid crystal display 100 have good display quality.

In view of the foregoing, in the different embodiments of the present disclosure, by using the light scattering particles in the light scattering adhesive layer to scatter the light entering the light scattering adhesive layer, the reflective liquid crystal display can have higher ambient light utilization rate and provide a display screen with high contrast and high visibility.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

1. A reflective liquid crystal display, comprising:
a reflective layer;
a light scattering adhesive layer positioned on the reflective layer, the light scattering adhesive layer including an adhesive layer and a plurality of light scattering particles dispersing in the adhesive layer, and a material of the adhesive layer includes an optical clear adhesive, an optical clear resin, or a combination thereof;
an array substrate positioned on the light scattering adhesive layer;
a color filter substrate disposed opposite to and on the array substrate; and
a liquid crystal layer disposed between the array substrate and the color filter substrate.

2. The reflective liquid crystal display of claim 1, wherein the light scattering adhesive layer is in direct contact with the array substrate.

3. The reflective liquid crystal display of claim 1, wherein the light scattering adhesive layer is in direct contact with the reflective layer.

4. The reflective liquid crystal display of claim 1, wherein the plurality of light scattering particles include an inorganic particle, an organic particle, or a combination thereof.

5. The reflective liquid crystal display of claim 4, wherein a material of the inorganic particle includes silicon dioxide, titanium dioxide, aluminium oxide, indium oxide, tin oxide, antimony trioxide, zinc oxide, zirconium dioxide, indium tin oxide, glass, or a combination thereof.

6. The reflective liquid crystal display of claim 4, wherein a material of the organic particle includes polycarbonate, polyurethane, epoxy, acrylic resin, phenol formaldehyde resin, or a combination thereof.

7. The reflective liquid crystal display of claim 1, wherein a particle size of each light scattering particle ranges between about 3 μm and about 50 μm.

8. The reflective liquid crystal display of claim 1, wherein an average particle size of the plurality of light scattering particles ranges between about 3 μm and about 50 μm.

9. (canceled)

10. The reflective liquid crystal display of claim 1, wherein a thickness of the light scattering adhesive layer ranges between about 30 μm and about 100 μm.
